(19) United States
(12) Patent Application Publication
(10) Pub. No.: US 2012/0068991 A1
(43) Pub. Date: Mar. 22, 2012

(54) ACTIVE MATRIX DISPLAY DEVICES AND ELECTRONIC APPARATUSES USING THE SAME

(75) Inventor: Hirofumi Watsuda, Kobe (JP)

(73) Assignee: CHIMEI INNOLUX CORPORATION, Miao-Li County (TW)

(21) Appl. No.: 13/232,694

(22) Filed: Sep. 14, 2011

(30) Foreign Application Priority Data
Sep. 17, 2010 (JP) 2010-209255

(51) Int. Cl. G09G 3/36; G09G 5/00

(52) U.S. Cl. 345/212; 345/87

(57) ABSTRACT

A display device capable of preventing display noise from being induced in the first frame period after a power source is input thereto. The display device includes pixels arranged in a matrix formed by rows and columns. Each pixel includes a pixel electrode, a display element, a storage capacitor coupled to the display element through the pixel electrode, and a switch element. The display device further includes a capacitive storage (CS) driving device which is synchronized with the scan line driving device to switch a potential of each electrode between two values one row by one row. Each electrode is disposed opposite to corresponding pixel electrode through a storage capacitor and is coupled to a corresponding CS line. After a power source is input and before the first scanning operation is performed, the CS driving device sets a potential of each capacitive storage line to one of the two values.

### CROSS REFERENCE TO RELATED APPLICATIONS

This Application claims priority of Japan Patent Application No. 2010-209255, filed on Sep. 17, 2010, the entirety of which is incorporated by reference herein.

### BACKGROUND OF THE INVENTION

1. Field of the Invention

The invention relates to an active matrix display device and an electronic apparatus using the same. The active matrix display device comprises pixels arranged in a matrix formed by rows and columns. Each pixel comprises a pixel electrode, a display element, a storage capacitor coupled to the display element through the pixel electrode, and a switch element.

2. Description of the Related Art

In an active matrix display device comprising pixels arranged in a matrix formed by rows and columns, each pixel comprises a switch element disposed around crossover points of a data line (also referred to as “source line”) and a scan line (also referred to as “gate line”). Each pixel further comprises a pixel electrode formed on one substrate where the switch element is also formed and a common electrode formed on another substrate which is disposed opposite to the one substrate via a liquid crystal layer. The common electrodes couple all of the pixels to common power (such as ground potential). The switch element is turned on in response to a scan signal of the gate line in the pixel row where the corresponding pixel is disposed. The period when the switch element is turned on is generally referred to as “scan period”. In the scan period, the pixel electrode is coupled to the source line in the pixel column where the corresponding pixel is disposed through the switch element and applied by a signal voltage. Accordingly, a potential difference between the pixel element and the common electrode is generated to change the alignment of the liquid crystal molecules of the liquid crystal layer.

Each pixel further comprises a storage capacitor for holding the signal voltage with charges during a period which occurs after the currently scan period finishes and the next scan period starts; which is one cycle period for updating image data (one frame period). The storage capacitor comprises a first terminal coupled to the pixel element and a second terminal coupled to a capacitive storage line (referred to as a CS line).

In prior arts, capacitive coupling driving is used to reduce power consumption of an active matrix liquid crystal display device. In a case where capacitive coupling driving is used, the CS line and the gate line are disposed in parallel and in each pixel row. For capacitive coupling driving, a gate driver which drives the gate lines is synchronized with a CS driver which drives the CS lines. For each pixel row, the CS line disposed in the pixel row is inversely driven after the scan period. By the driving of the CS line, the pixel electrode is applied a fixed bias through the storage capacitor (JP3402277, Japan patent reference 1). Thus, capacitive coupling driving is also referred to as pixel potential shift (PPS) driving. Compared with other driving methods excluding PPS driving, PPS driving can decrease the amplitudes of voltage signals, so that power consumption can be reduced.

### PRIOR ART REFERENCE

[Japan patent reference 1] JP 3402277

However, in an active matrix liquid crystal display device with capacitive coupling driving, noise may be induced in the first frame period after power is applied to the device. This is because the potential of each CS line is not fixed till the first frame period is finished. Thus, in the first frame period, each CS line, at times, may not be regularly driven by the desired inversion driving, resulting in noise to occur on images displayed on a panel of the display device.

### BRIEF SUMMARY OF THE INVENTION

The invention provided an active matrix display device and an electronic apparatus using the same to solve the problems of the prior arts. The active matrix display device is capable of using a capacitive coupling driving to prevent display noise from being induced in the first scan frame period after a power source is input thereto.

In order to achieve the above objective, an exemplary embodiment of an active matrix display device is provided. The active matrix display device comprises a plurality of pixels arranged in a matrix formed by pixel rows and pixel columns. Each of the pixels comprises a pixel electrode, a display element, a storage capacitor coupled to the display element through the pixel electrode, and a switch element. The active matrix display device further comprises a signal line driving device, a scan line driving device, and a capacitive storage driving device. The signal line driving device drives a plurality of signal lines respectively disposed in the pixel columns. The scan line driving device sequentially drives a plurality of scan lines respectively disposed in the pixel rows and turns on the switch elements one pixel row by one pixel row, so that the pixel electrodes are coupled to the corresponding signal lines. The capacitive storage driving device is synchronized with the scan line driving device to drive a plurality of capacitive storage lines respectively disposed in the pixel rows. The capacitive storage driving device switches a potential of each of a plurality of electrodes between two values one pixel row by one pixel row. Each of the electrodes is disposed opposite to the corresponding pixel electrode through a storage capacitor and is coupled to the corresponding capacitive storage line. After a power source of the active matrix display device is input and before the scan line driving device starts scanning the scan lines, the capacitive storage driving device sets a potential of each of the capacitive storage lines to be at one of the two values.

Accordingly, the active matrix display device with capacitive coupling driving can prevent display noise from being induced in the first scan frame period after a power source is input thereto.

In one preferred embodiment, the active matrix display device further comprises a controller. The controller controls the capacitive storage driving device to set the potential of each of the capacitive storage lines to be at one of the two values. The controller generates a control signal, and the control signal corresponds to each of the capacitive storage lines or each of capacitive storage line sets. Each of the capacitive storage line sets comprises even numbers of capacitive storage lines comprising at least two capacitive storage lines.

The controller further controls the capacitive storage driving device to switch polarities of the capacitive storage lines between the two values by every one capacitive storage line or every one capacitive storage line set. In this case, the control signal generated by the controller has a polarity which corresponds to each of the capacitive storage lines and is controllable independently.

Moreover or alternately, the capacitive storage lines are divided into a first set composed of the capacitive storage lines in the odd pixel rows and a second set composed of the capacitive storage lines in the even pixel rows. The controller generates a first control signal for the first set of the capacitive storage lines and a second control signal for the second set of the capacitive storage lines.

In a preferred embodiment, the active matrix display device is a liquid crystal display device and further comprises a first substrate and a second substrate. A circuit is formed on the first substrate. The circuit comprises the signal lines, the scan lines, the pixel electrodes, the switch elements, the storage capacitors, and the capacitive storage lines. A common electrode is formed on the second substrate. The common electrode is disposed opposite to the circuit through a liquid crystal layer. The capacitive storage driving device and the circuit are formed on the first substrate. In an alternate preferred embodiment, the active matrix display device is a liquid crystal display device and further comprises a first substrate, a second substrate, and a driver integrated circuit. A circuit is formed on the first substrate. The circuit comprises the signal lines, the scan lines, the pixel electrodes, the switch elements, the storage capacitors, and the capacitive storage lines. A common electrode is formed on the second substrate. The common electrode is disposed opposite to the circuit through a liquid crystal layer. The driver integrated circuit comprises the signal line driving device, the scan line driving device, and the capacitive storage driving device.

In a preferred embodiment, the active matrix display device may be an electronic apparatus with a display device which has a function of displaying images to users, such as a television, a watch, a personal digital assistant (PDA), a notebook, a cellular phone, an automotive guidance device, a tablet game console, or a large electrical signboard.

An exemplary embodiment of an active matrix display device and an electronic apparatus using the same is provided. The active matrix display device adopts capacitive coupling driving and prevents display noise from being induced in the first scan frame period after a power source is input thereto.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 shows an exemplary embodiment of an active matrix display device;

FIG. 2 shows an exemplary embodiment of a circuit structure of respective pixels of an active matrix display device;

FIG. 3 shows a structure of a conventional CS driving device with capacitive coupling driving;

FIG. 4 shows an exemplary embodiment of a circuit structure of a CS sub-driving device;

FIG. 5 shows a timing chart of a CS driving circuit with conventional capacitive coupling driving;

FIG. 6 is a schematic view showing an exemplary embodiment of actions of various voltages and a control signal of an active matrix display device after a power source is input;

FIG. 7 is a timing chart of an operation of a conventional CS driving device with capacitive coupling driving after a power source of an active matrix display device is input thereto, particularly, after a control signal starts performing the normal action;

FIG. 8 shows an exemplary embodiment of a CS driving device with capacitive coupling driving;

FIG. 9 is a timing chart of an exemplary embodiment of an operation of a CS driving device with capacitive coupling driving;

FIG. 10 is a timing chart of an exemplary embodiment of an operation of a CS driving device with capacitive coupling driving after a power source of an active matrix display device is input thereto, particularly, after a control signal starts performing the normal action;

FIG. 11 is a table showing an exemplary embodiment of a combination of polarity signals provided to a CS driving device in a capacitive coupling driving; and

FIG. 12 an exemplary embodiment of an electrical apparatus with an active matrix display device.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

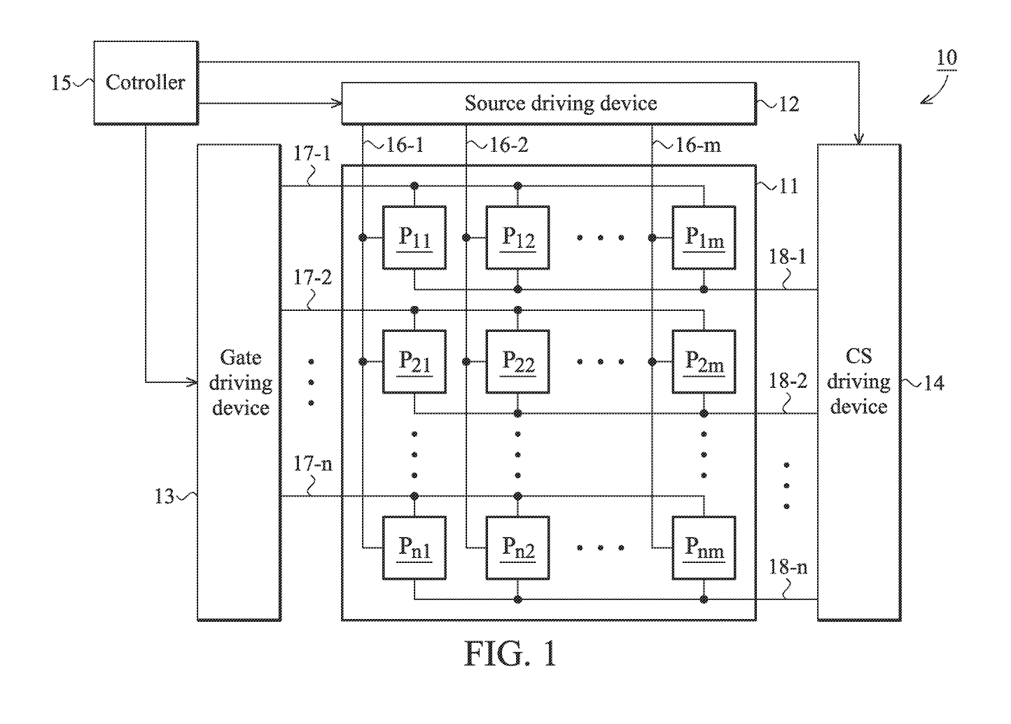

FIG. 1 shows an exemplary embodiment of an active matrix display device. A display device 10 of FIG. 1 comprises a display panel 11, a source driving device 12, a gate driving device 13, a capacitive storage (CS) driving device 14, and a controller 15.

The display panel 11 comprises a plurality of pixels P₁₁˜Pₙₘ (each of m and n is an integer) which are arranged in a matrix formed by rows and columns. The display panel 11 further comprises a plurality of source lines 16-1˜16-m which are respectively disposed on the pixel columns, a plurality of gate lines 17-1˜17-n which are interlaced with the source lines 16-1˜16-m and respectively disposed on the pixel rows, and a plurality of CS lines 18-1˜18-n which are parallel to the gate lines 17-1˜17-n and respectively disposed on the pixel rows.

The source driving device 12 is a signal line driving circuit which drives source lines 16-1˜16-m according to image data signals to apply signal voltages to the pixels P₁₁˜Pₙₘ through the source lines 16-1˜16-m. The gate driving device 13 is a scan line driving circuit which drives the gate lines 17-1˜17-n in a predetermined sequence to control the signal voltages applied to the pixels P₁₁˜Pₙₘ through the gate lines 17-1˜17-n. The gate driving device 13 may select pixels in one certain pixel row by interlaced scanning or sequential scanning, so that the pixels in the selected pixel row are applied by the signal voltages through the source lines. For example, in a liquid crystal display device, the applying of the signal voltages induces variations in the alignment of liquid crystal molecules, so that the backlight or environmental light (reflected light) is polarized for displaying images.

The CS driving device 14 is a capacitive storage line driving circuit which is synchronized with the gate driving device 13 to drive the CS lines 18-1˜18-n. In each pixel, a storage capacitor is disposed between a pixel electrode and the corresponding CS line to hold the signal voltage applied to the pixel until the pixel is selected for a next time. The CS driving device 14 applies a voltage to the storage capacitors through the CS lines 18-1˜18-n.

The controller 15 is synchronized with the source driving device 12, the gate driving device 13, and the CS driving device 14 and used to control the operations of the above devices.

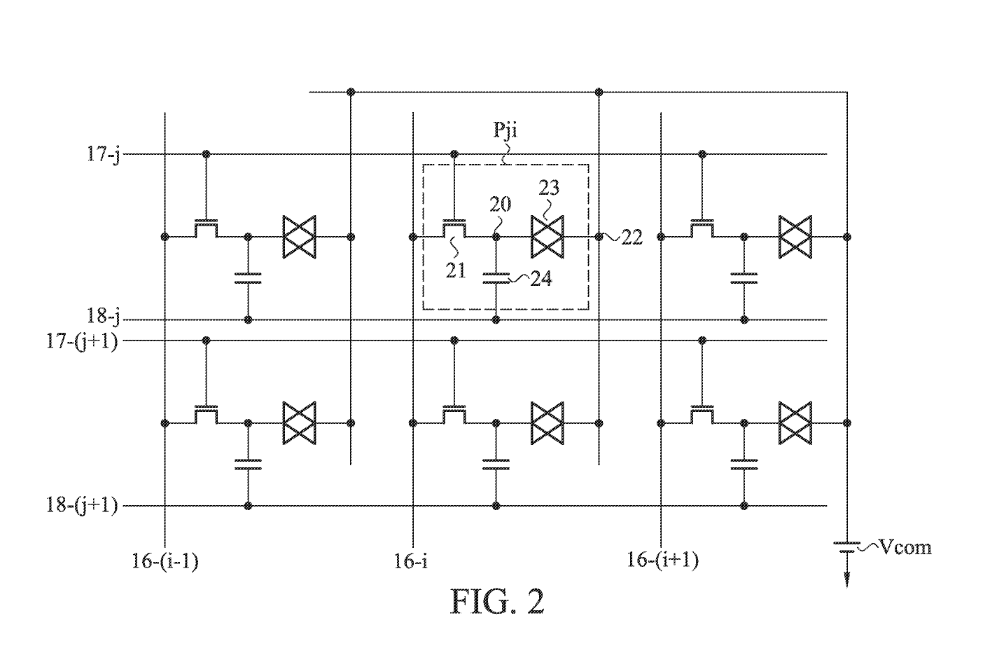

FIG. 2 shows an exemplary embodiment of a circuit structure of respective pixels of an active matrix display device. A pixel Pⱼᵢ (each of I and j is an integer, 1≦i≦m, and 1≦j≦n) is disposed around a crossover point of the i-th source line 16-i and the j-th gate line 17-i which correspond to the pixel Pⱼᵢ.

The pixel Pⱼᵢ comprises a pixel electrode 20, a switch element 21 formed on one substrate where the pixel electrode 20 is also formed, a common electrode 22 formed on another substrate which is disposed opposite to the pixel electrode 20 via a liquid crystal layer. For clear description, a liquid crystal display element 23 is shown between the pixel electrode 20 and the common electrode 20.

The common electrode 22 couples all of the pixels P₁₁˜Pₙₘ to a common fixed power source V_{COM} (such as ground or fixed power).

A control terminal of the switch element 21 is coupled to the gate line 17-j, and the switch element 21 is turned on in response to a scan signal on the gate electrode 17-j. In a scan period when the switch element 21 is turned on, the pixel electrode 20 is coupled to the source line 16-i through the switch element 21. By applying a signal voltage to the pixel electrode 20, potential difference between the pixel electrode 20 and the common electrode 22 is induced to drive the liquid crystal display element 23.

The pixel Pⱼᵢ further comprises a storage capacitor 24 which holds the signal voltage with charges during a period which occurs after the currently scan period finishes and the next scan period starts; that is one cycle period of re-writing image data (one scan frame period). One terminal of the storage capacitor 24 is coupled to the pixel electrode 20, and the other terminal thereof is coupled to the CS line 18-j.

Each of the CS lines 18-1˜18-n is synchronized with the driving of the gate lines 17-1˜17-n through the CS driving device 14 and driven by inversion driving. By the driving of the CS line, the pixel electrode 20 is applied by a fixed bias through the storage capacitor 20. The way by which the potential of the pixel electrode is shifted by the driving of the CS line is referred to as capacitive coupling driving. Compared with other driving methods excluding capacitive coupling driving, the amplitudes of the voltage signals can be decreased, so that the power consumption can be reduced.

In the following, the structure of the CS driving device 14 and the driving of the CS lines by the CS driving device 14 will be described.

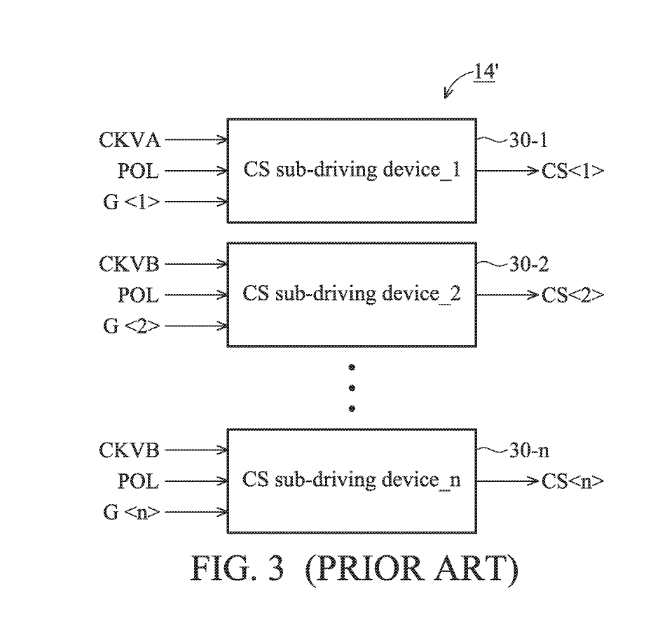

FIG. 3 shows a structure of a conventional CS driving device 14′ with capacitive coupling driving.

The CS driving device 14′ comprises CS sub-driving devices 30-1˜30-n respectively corresponding to the CS lines 18-1˜18-n. The CS sub-driving devices 30-1˜30-n are input by scan signals G<1>˜G<n> which are applied to the gate lines 17-1˜17-n or other appropriate signals from the gate driving device 13 or the controller 15 respectively. A common polarity signal POL from the controller 15 is input to the CS sub-driving devices 30-1˜30-n. In the embodiment, a first clock signal CKVA is input to the CS sub-driving devices 30-1, 30-3, . . . ˜30-(n−1) corresponding to the odd pixel rows, while a second clock signal CKVB is input to the CS sub-driving devices 30-2, 30-4, . . . ˜30-n corresponding to the even pixel rows, wherein the difference between the phases of the first clock signal CKVA and the second clock signal CKVB is 180 degrees.

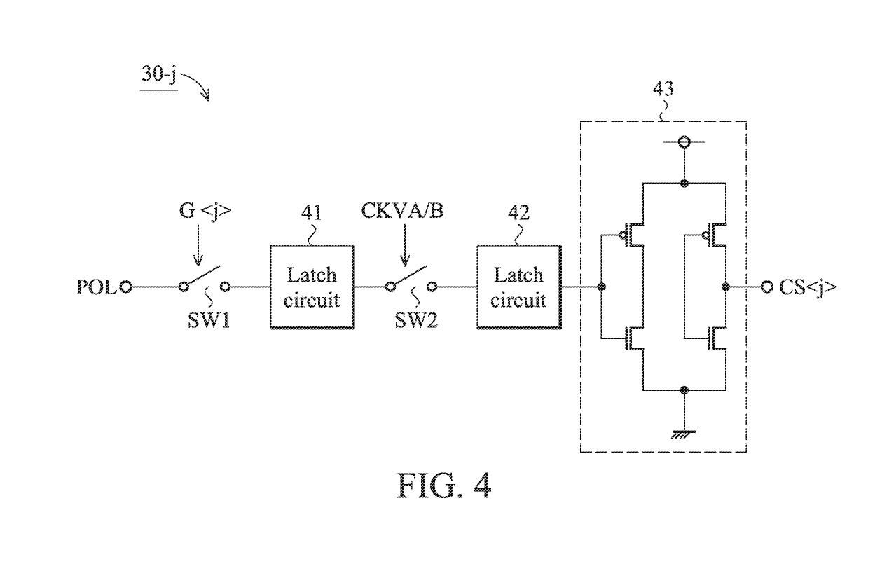

FIG. 4 shows an exemplary embodiment of a circuit structure of a CS sub-driving device 30-j (j is an integer, and 1≦j≦n).

The CS sub-driving device 30-j comprises a first latch circuit 41 and a second latch circuit 42. The CS sub-driving device 30-j further comprises a first switch SW1 which is disposed between an input terminal of the polarity signal POL and an input portion of the first latch circuit 41 and turned on/off in response to the scan signal G<j> and a second switch SW2 which is disposed between an output portion of the first latch circuit 41 and an input portion of the second latch circuit 42 and turned on/off in response to the first/second clock signal CKVA/CKVB. When the CS sub-driving device 30-j corresponds to an odd pixel row among the pixels, the second switch SW2 operates in response to the first clock signal CKVA. When the CS sub-driving device 30-j corresponds to an even pixel row among the pixels, the second switch SW2 operates in response to the second clock signal CKVB. The CS sub-driving device 30-j further comprises an output buffer circuit 43 which is disposed between an output portion of the second latch circuit 32 and an output terminal of a CS line voltage CS<j>. As shown in FIG. 4, the output buffer circuit 43 may be composed of two NOT circuits which are coupled in parallel, wherein each of the NOT circuits is composed by MOSFETs.

In a specific scan frame period, when the pixels on the j-th pixel row are scanned, the scan signal G<j> is at a high level. Thus, in the CS sub-driving device 30-j, the first switch SW1 is turned on in response to the scan signal G<j>. At this time, if the polarity signal POL is at a high level voltage (High), the first latch circuit 41 outputs a high level signal. Then, the second switch SW2 is turned on in response to the clock signal CKVA or CKVB, and the second latch circuit 42 outputs a high level signal. In response to the high level signal, the output buffer circuit 43 outputs a high level signal. That is, the CS line voltage CS<j> output by the CS sub-driving device 30-j is at a high level.

After, in the next scan frame period, when the scan signal G<j> is at the high level voltage to scan the pixels on the j-th pixel row again, the polarity signal POL is at a low level voltage (Low). Thus, the first latch circuit 41 outputs a low level signal. At this time, only if the second switch SW2 is turned off in response to the clock signal CKVA or CKVB, the CS sub-driving device 30-j outputs the high level CS line voltage CS<j>. If the second switch SW2 is turned on in response to the clock signal CKVA or CKVB, the second latch circuit 42 outputs a low level signal. In response to the low level signal, the output buffer circuit 43 outputs a low level signal. In other words, the CS line voltage CS<j> output by the CS sub-driving device 30-j is switched from the high level voltage to the low level voltage in response to the clock signal CKVA or CKVB. Accordingly, the CS sub-driving device 30-j can drive the corresponding CS line 18-j by inversion driving.

Because of the above description, the CS sub-driving device 30-j may be composed of semiconductor active elements. Thus, the CS driving circuit may be formed on the same substrate as a circuit comprising the pixel electrodes, switch elements, storage capacitors, source lines, gate lines, and CS lines. Accordingly, manufacture steps and cost can be decreased, and the sizes of the display device can be minimized. In other embodiments, the CS driving device may be disposed on a driving device circuit in company with the source lines and the gate lines, wherein the driving device circuit is independently configured to be outside of a display panel.

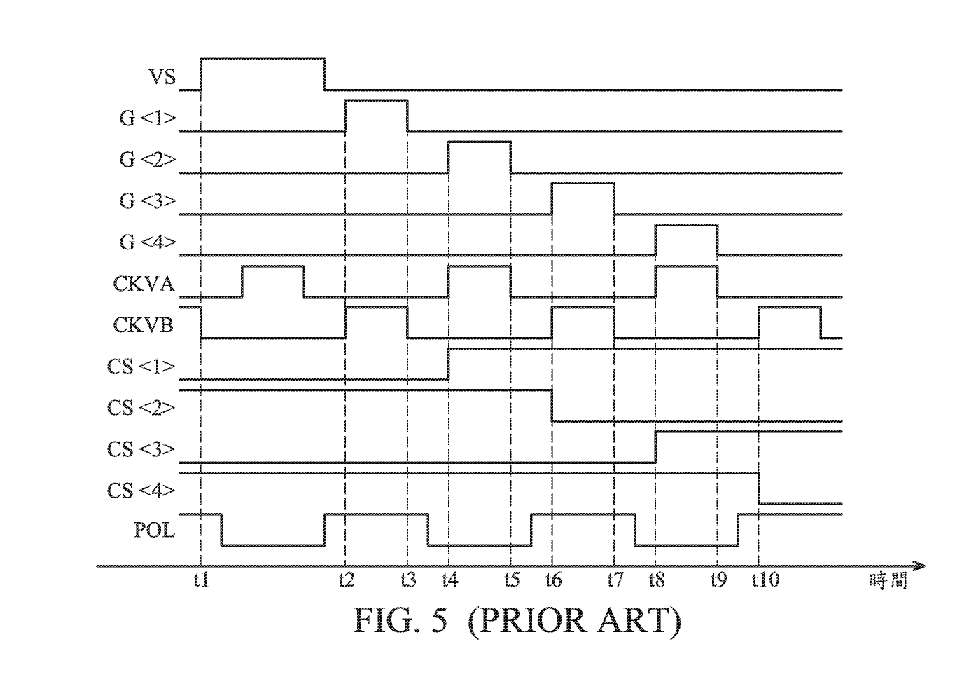

FIG. 5 shows a timing chart of the CS driving circuit with conventional capacitive coupling driving.

At a time point t1, a vertical synchronization signal VS is at a high level voltage, and the scanning of the pixels in the respective pixel rows starts sequentially. The period from the time point t1 to the time point when the vertical synchronization signal VS is at the high level voltage at the next time is defined as one scan frame period, wherein in one scan frame, the pixels in all of the pixel rows are scanned.

After the high level vertical synchronization signal VS occurs, the first scan signal G<1> is at a high level between time points t2 and t3. When the first scan signal G<1> is at the high level, the pixels in the pixel row (such as the pixels P₁₁˜P₁ₘ in the first pixel row) corresponding to the first scan signal G<1> are scanned. After, the scan signals G<2>˜G<n> are at the high level sequentially. In the embodiment, the time points respectively when the scan signals G<1>˜G<n> are at the high level do not overlap during one scan frame period.

The timing of the high/low level switching of the first clock signal CKVA is the same as that of the scan signals G<2>, G<4> . . . G<n> provided to the pixels in the even pixel rows. The second clock signal CKVB is a signal with a different phase from the phase of the first clock signal CKVB by 180 degrees. Accordingly, the timing of the high/low level voltage switching of the second clock signal CKVB is the same as that of the scan signals G<1>, G<3> . . . G<n−1> provided to the pixels in the odd pixel rows.

For example, when the pixels in the first pixel rows are scanned (t2-13), the first scan signal G<1> is at the high level voltage. At this time, in the embodiment of FIG. 5, the polarity signal POL is at the high level voltage. Thus, the CS sub-driving device 30-1 which is disposed by corresponding to the first pixel row is input by the high level polarity signal POL. The CS line voltage CS<1> output by the CS sub-driving device 30-1 remains at the low level voltage without variation.

Then, when the pixels in the second pixel rows are scanned (t4˜t5), the second scan signal G<2> is at the high level voltage. At this time, in the embodiment of FIG. 5, the polarity signal POL is at the low level voltage. Thus, the CS sub-driving device 30-2, which is disposed by corresponding to the second pixel row is input by the low level polarity signal POL. The CS line voltage CS<2> output by the CS sub-driving device 30-2 remains at the high level without variation.

Further, when the second scan signal G<2> is at the high level, the first clock signal CKVA is at a high level. In response to the first clock signal CKVA being at the high level, at the time point t4, the CS line voltage CS<1> output by the CS sub-driving device 30-1 is switched to the high level from the low level.

Then, when the pixels in the third pixel rows are scanned (t6˜17), the third scan signal G<3> is at the high level. At this time, in the embodiment of FIG. 5, the polarity signal POL is at the high level. Thus, the CS sub-driving device 30-3 which is disposed by corresponding to the third pixel row is input by the high level polarity signal POL. The CS line voltage CS<3> output by the CS sub-driving device 30-3 remains at the low level without variation.

Further, when the third scan signal G<3> is at the high level, the second clock signal CKVB is at a high level. In response to the second clock signal CKVB being at the high level, at the time point t6, the CS line voltage CS<2> output by the CS sub-driving device 30-2 is switched to the low level from the high level.

Then, when the pixels in the fourth pixel rows are scanned (t8˜t9), the fourth scan signal G<4> is at the high level. At this time, in the embodiment of FIG. 5, the polarity signal POL is at the low level. Thus, the CS sub-driving device 30-4 which is disposed by corresponding to the fourth pixel row is input by the low level polarity signal POL. The CS line voltage CS<4> output by the CS sub-driving device 30-4 remains at the high level without variation.

Further, when the third scan signal G<4> is at the high level, the first clock signal CKVA is at the high level. In response to the second clock signal CKVA being at the high level, at the time point t8, the CS line voltage CS<3> output by the CS sub-driving device 30-3 is switched to the high level from the low level.

After, by synchronizing with scanning of the pixels in the respective pixel rows, the CS line voltages CS<4>˜CS<n> are driven with the same inversion driving.

For the conventional CS driving device 14′ with capacitive coupling driving, the CS lines may not be regularly driven by inversion driving in the first scan frame period occurring after a power source is input thereto. When the CS lines are not regularly driven by the inversion driving, noise occurs on images displayed on a panel of the display device.

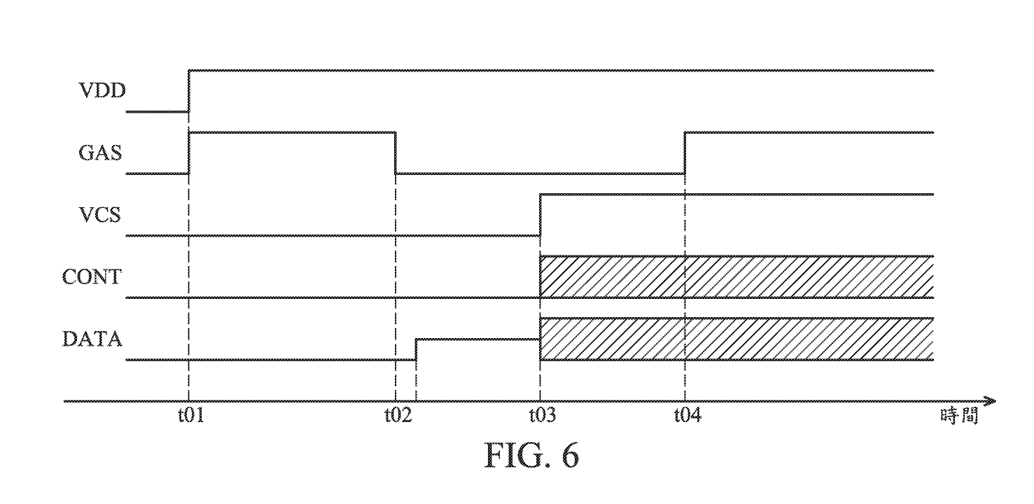

FIG. 6 is a schematic view showing actions of various voltages and a control signal of an active matrix display device after a power source is input thereto.

At a time point t01, the power source of the display device is turned on, and a power voltage VDD rises. At the same time, a signal GAS which controls the outputting of the scan signals G<1>˜G<n> from the gate driving device 13 is switched to a high level voltage.

After, at a time point t02, in order to eliminate image displaying, the signal GAS is switched to a low level voltage. When the signal GAS is at the low level voltage, all of the scan signals G<1>˜G<n> output from the gate driving device 13 are at the high level voltage. To make all of the scan signals G<1>˜G<n> to be at the high level, all of the pixels are selected to eliminate image displaying, which is referred to as “gate-all-select”.

Then, at a time point t03, the signal GAS, remains, at the low level. However, the power voltages of various portions of the display device (for simplification, FIG. 6 only shows the power voltage VCS used by the CS driving device), image data DATA, and a control signal CONT which controls the various portions of the display device for displaying images according to the image data DATA start performing normal actions. The control signal CONT is a collective control signal which comprises the vertical synchronization signal VS, the clock signals CKVA and CKVB, and the polarity signal POL.

At a final time point t04, the signal GAS is switched to the high level. The gate driving device 13 starts scanning the pixels in the respective pixel rows and outputs high level scan signals G<1>˜G<n> sequentially.

However, there is a problem which occurs in the period t03˜t04 when the control signal CON performs the normal action while the signal GAS, remains, at the low level.

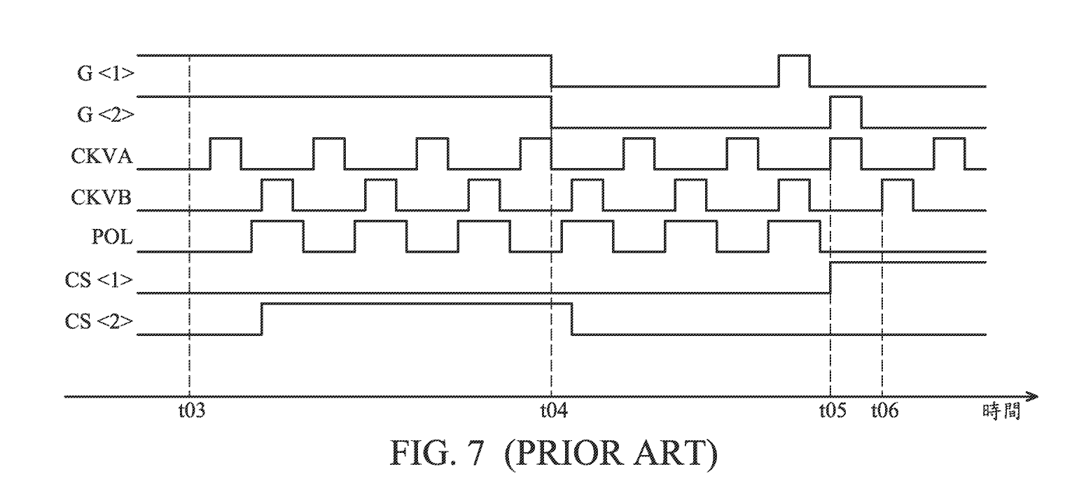

FIG. 7 is a timing chart of the operation of the conventional CS driving device 14′ with capacitive coupling driving after a power source of the active matrix display device is input thereto; particularly, after the control signal CONT starts performing the normal action.

Referring to FIG. 6, as the above description, at the time point t03, the control signal CONT comprising the vertical synchronization signal VS, the clock signals CKVA and CKVB, and the polarity signal POL starts to perform normal actions. FIG. 7 shows the first clock signal CKVA, the second clock signal CKVB, and the polarity signal POL of the control signal CONT. At the same time, the signal GAS is at the low level, as shown in FIG. 6. Thus, all of the scan signals G<1>˜G<n> are at the high level. For simplification, FIG. 7 only shows the scan signals G<1> and G<2> which are used to scan the pixels in the first and second pixel rows.

In the period t03˜t04 ending at the time point t04 when the signal GAS is switched to the high level voltage, the scan signals remain at the high level voltage. Thus, the polarity of the CS line voltage output by each respective CS sub-driving device is the same as the polarity (high level or low level) of the polarity signal POL when the input clock signal CKVA or CKVB is at the high level voltage. In the embodiment of FIG. 7, the polarity signal POL is switched between the high level voltage and the low level voltage by a predetermined period. Accordingly, the polarity signal POL is at the low level in the period when the first clock signal CKVA is at the high level voltage and the second clock signal CKVB is at the low level voltage. Also, the polarity signal POL is at the high level in the period when the second clock signal CKVB is at the high level voltage and the first clock signal CKVA is at the high level voltage. Thus, in the period t03˜t04, the CS line voltage CS<1> which is output by the CS sub-driving device 30-1 corresponding to the first pixel row is at the low level voltage, while the CS line voltage CS<2> which is output by the CS sub-driving device 30-2 corresponding to the second pixel row is at the high level voltage.

At the time point t04, the signal GAS is switched to the high level voltage. As the description of FIG. 5, the gate driving device 13 starts to perform a normal scanning operation. Thus, after all of the scan signals G<1>˜G<n> are switched to the low level voltage, the scan signals G<1>˜G<n> are switched to the high level voltage sequentially.

When the second clock signal CKVB rises at a first time after the scan signals G<1> and G<2> are switched to the low level voltage, the CS line voltage CS<2> is switched to the low level voltage from the high level voltage. This is because the CS line voltage CS<2> is switched to the polarity which is the same as the polarity of the polarity signal POL occurring before the scan signal G<2> is switched to the low level voltage according to the operation of the latch circuit of the CS sub-driving device 30-2.

In the normal scan operation performed by the gate driving device 13, when the first clock signal CKVA rises at the first time (t05) after the pixels in the first pixel row is scanned, the CS line voltage CS<1> is switched to the high level voltage from the low level voltage. Then, when the second clock signal CKVB rises at the first time (t06) after the pixels in the second pixel row are scanned, the CS line voltage CS<2> should be switched to the low level voltage from the high level voltage. However, since the CS line voltage CS<2> is originally at the low level voltage, the CS line voltage CS<2> remains at the low level voltage in the first scan frame period.

Accordingly, for the conventional CS driving device 14′ with capacitive coupling driving, the CS lines are not regularly driven by inversion driving in the first scan frame period after the power source of the display device is input thereto. When the CS lines are not regularly driven by the inversion driving, noise may occur on images displayed on a panel of the display device.

The present invention is disclosed to solve the problems of the display noise induced in the conventional CS driving device 14′ with the capacitive coupling driving. In order to make all of the CS lines regularly driven by the inversion driving in the first scan frame period after the power source of the display device is input thereto, the CS lines may be set at a predetermined potential in advance before the first scan frame period.

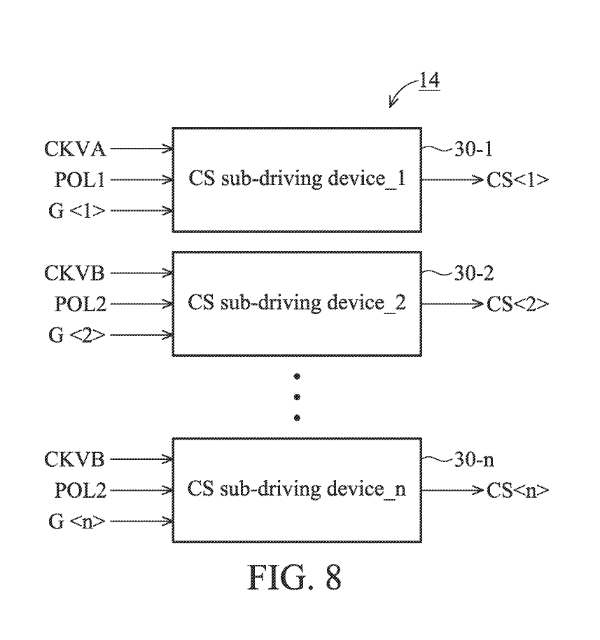

FIG. 8 shows an exemplary embodiment of the CS driving device 14 with capacitive coupling driving.

By comparing the CS driving device 14 of FIG. 8 with the conventional CS driving device 14′ with the capacitive coupling driving of FIG. 3, the difference therebetween is that the common polarity signal POL is input to all of the CS sub-driving devices 30-1˜30-n in the CS driving device 14′ of FIG. 3, while, for the CS driving device 14 of FIG. 8, a first polarity signal POL1 is input to the CS sub-driving devices 30-1, 30-3 . . . 30-(n−1) corresponding to the pixels in the odd pixel rows, and a second polarity signal POL2 is input to the CS sub-driving devices 30-2, 30-4 . . . 30-n corresponding to the pixels in the even pixel rows. The polarity of the second polarity signal POL2 is inverse to that of the first polarity signal POL1. The first and second polarity signals POL1 and POL2 are provided by the controller 15.

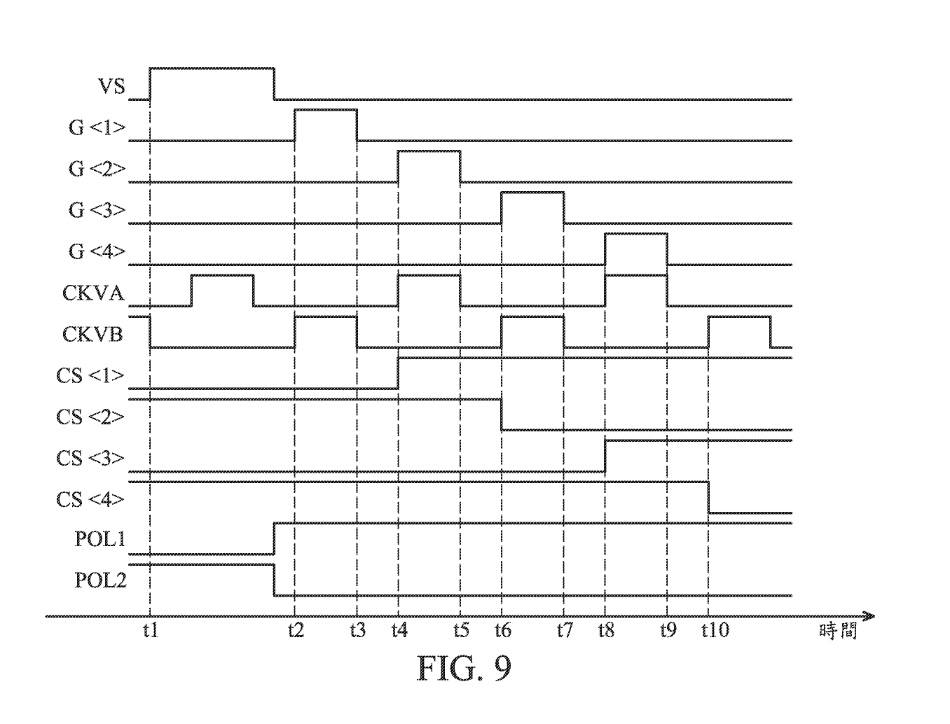

FIG. 9 is a timing chart of the operation of the CS driving device 14 with the capacitive coupling driving.

In FIG. 9, the polarity signal POL is divided into the first and second polarity signals POL1 and POL2.

For the conventional CS driving device 14′ with the capacitive coupling driving of FIG. 5, the polarity signal POL is switched between the high level voltage and low level voltage in response to whether the scanned pixels belong to an odd pixel row or an even pixel row. For example, the polarity signal POL is switched between the high level voltage and low level voltage by a predetermined cycle. In a specific scan frame period, the polarity signal POL is at the high level voltage in the period when the pixels in the odd pixel rows are scanned, while the polarity signal POL is at low level voltage in the period when the pixels in the even pixel rows are scanned. Thereafter, in the next scan frame period, the polarity signal POL is at the low level in the period when the pixels in the odd pixel rows are scanned, while the polarity signal POL is at high level voltage in the period when the pixels in the even pixel rows are scanned.

In the operation of the CS driving device 14 with the capacitive coupling driving of FIG. 9, in a specific scan frame period, the first polarity signal POL1 is at the high level voltage and the second polarity signal POL2 is at the low level voltage when the pixels in the respective pixel rows are scanned. Thereafter, in the next scan frame period, the polarities of the first and second polarity signals POL1 and POL2 are inverse, that is, the first polarity signal POL1 is at the low level voltage and the second polarity signal POL2 is at the high voltage. In other words, the polarities of the first and second polarity signals POL1 and POL2 are switched once in each of the scan frame periods.

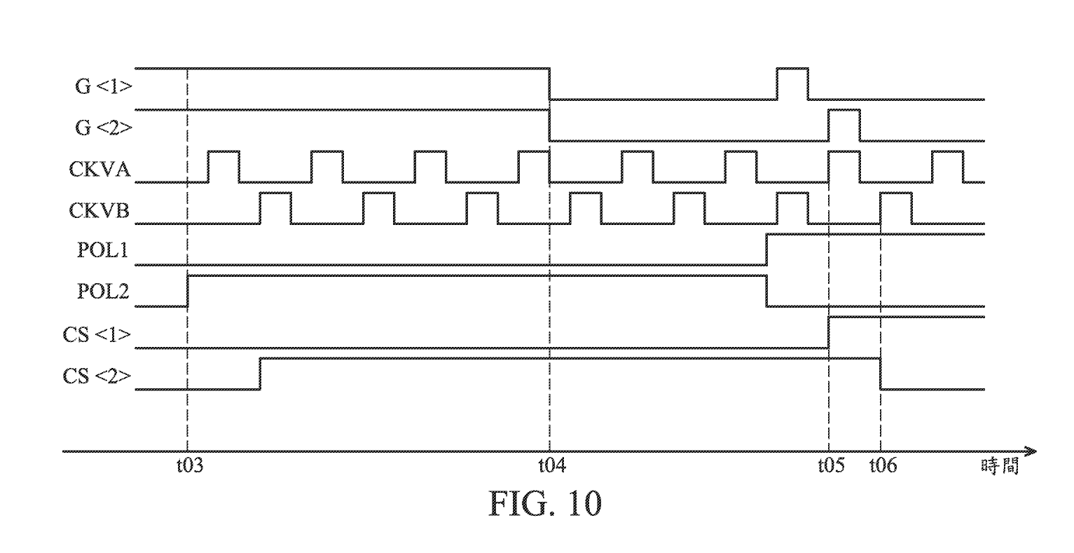

FIG. 10 is a timing chart of the operation of the CS driving device 14 with the capacitive coupling driving after a power source of the active matrix display device is input thereto; particularly, after the control signal CONT starts performing the normal action.

As shown in FIG. 6, at the time point t03, the control signal CONT comprising the vertical synchronization signal VS, the clock signals CKVA and CKVB, and the polarity signal POL starts to perform a normal action. FIG. 10 shows the first clock signal CKVA, the second clock signal CKVB, the first polarity signal POL1, and the second polarity signal POL2 of the control signal CONT. At the same time, the signal GAS is at the low level, as shown in FIG. 6. Thus, all of the scan signals G<1>˜G<n> are at the high level. For simplification, FIG. 10 only shows the scan signals G<1> and G<2> which are used to scan the pixels in the first and second pixel rows.

In the period t03˜t04 ending at the time point t04 when the signal GAS is switched to the high level voltage, the scan signals remain at the high level voltage. Thus, the polarities of the CS line voltages CS<1>, CS<3> . . . CS<n−1> output from the CS sub-driving device 30-1, 30-3 . . . 30-(n−1) corresponding to the odd pixel rows are the same as the polarity of the first polarity signal POL1 occurring when the first clock signal CKVA is at the high level voltage; the polarities of the CS line voltages CS<2>, CS<4> . . . CS<n> output from the CS sub-driving device 30-2, 30-4 . . . 30-n corresponding to the even pixel rows are the same as the polarity of the second polarity signal POL2 occurring when the second clock signal CKVB is at the high level voltage. According to the embodiment of FIG. 10, in the time period t03˜t04, the first polarity signal POL1 remains at the low level voltage, while the second polarity signal POL2 remains at the high level voltage. Thus, in the time period t03˜t04, the CS line voltage CS<1> output from the CS sub-driving device 30-1 disposed by corresponding to the first pixel row is at the low level, and the CS line voltage CS<2> output from the CS sub-driving device 30-2 disposed by corresponding to the second pixel row is at the high level

At the time point t04, the signal GAS is switched to the high level voltage. As the description of FIG. 5, the gate driving device 13 starts to perform a normal scanning operation. Thus, after all of the scan signals G<1>˜G<n> are switched to the low level voltage, the scan signals G<1>˜G<n> are switched to the high level voltage sequentially.

When the second clock signal CKVB rises at a first time after the scan signals G<1> and G<2> are switched to the low level voltage, for the conventional CS driving device 14′ with the capacitive coupling driving as shown in FIG. 7, the CS line voltage CS<2> is switched to the low level from the high level voltage. In the embodiment, since the common polarity signal of the prior arts is divided into the above two polarity signals POL1 and POL2, the polarity of the CS line voltage CS<2> is not inverted. The CS lines are set at a predetermined potential in advance before the first scan frame period after the power source of the display device is input thereto. Thus, as shown in FIG. 10, even for the first scan frame period after the power source of the display device is input thereto, all of the CS lines are regularly driven by the inversion driving, which prevents the display noise from being induced.

According to the above embodiments of the active matrix display device, row inversion driving, in which the polarities of the CS lines are inverted once in each pixel row, is given as an example. However, in other embodiments, frame inversion driving, in which the polarities of the CS lines are inverted once in each scan frame period, may be adopted. For the frame inversion driving, the first and second polarity signals POL1 and POL2 may be the same.

For the row inversion driving, it is not necessary to invert the polarities of the CS lines once in every pixel row. The polarities of the CS lines may be inverted once for every even pixel rows (equal to or larger than two pixel rows). For simplification, it is considered that the polarities of the CS lines are inverted once in every two pixel rows. The CS sub-driving devices 30-1 and 30-2 corresponding to the first and second pixel rows are input by the first polarity signal POL1, while the CS sub-driving devices 30-3 and 30-4 corresponding to the third and fourth pixel rows are input by the second polarity signal POL2, wherein the polarity of the second polarity signal POL2 is inverse to the polarity of the first polarity signal POL1. After, the first and second polarity signals POL1 and POL2, alternately, are input to the CS sub-driving devices corresponding to every two pixel rows.

According to the above description, the increment of the number of polarity signals and the usage of hardware, software, or the combination of the hardware and the software can be implemented for switch timing of the driving of the polarity signals by the inversion driving, so that adoption of flexible inversion driving may be implemented in fabricated display devices. Thus, every one CS line or every even numbers of CS lines (comprising at least two CS lines) are disposed by corresponding to one control signal.

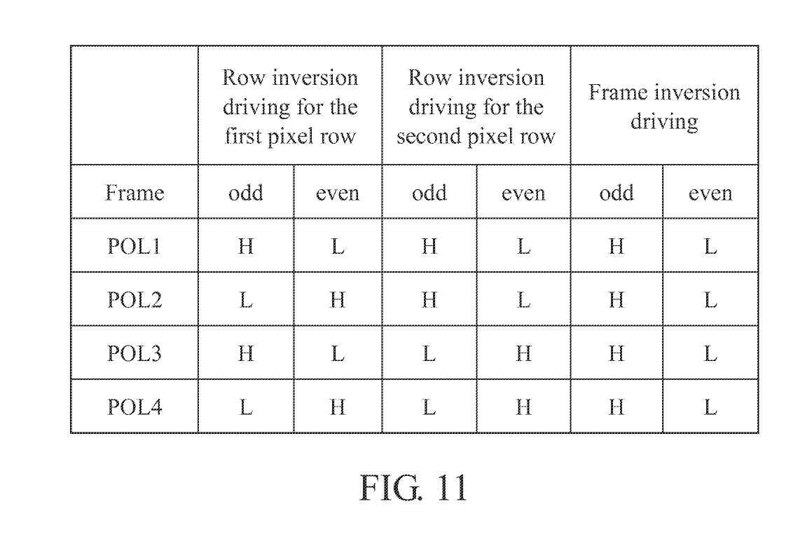

For example, when the polarity signal is divided into four polarity signals POL1, POL2, POL3, and POL4, in the above row inversion driving and frame inversion driving with every one or two pixel rows, the respective polarity signals POL1, POL2, POL3, and POL4 are switched between the high level voltage and low level voltage in the odd (or even) scan frame periods and the even (or odd) scan frame periods, as shown in FIG. 11. For the row inversion driving, the polarities of the CS lines are inverted by every one CS line or every even numbers of adjacent CS lines (comprising at least two CS lines). In short, at least two polarity signals are required regardless of the number of CS lines driven by the inversion driving.

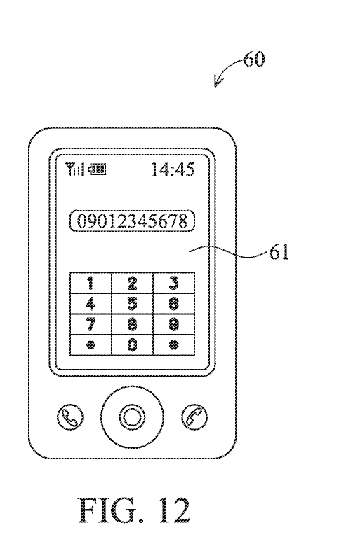

FIG. 12 an exemplary embodiment of an electrical apparatus with the active matrix display device of the above embodiments. An electrical apparatus 60 of FIG. 12 is shown as a cellular phone. However, the electrical apparatus 60 may be a television, a watch, a personal digital assistant (PDA), a notebook, a cellular phone, an automotive guidance device, a tablet game console, or a large electrical signboard.

The cellular phone 60 comprises a display device which has a display panel for showing information by images. The display device 61 may provide a touch function. The display device 61 displays information comprising the time and the states of the cellular phone 60, for example, the intensity of electric waves and remaining battery power. Further, the display device 61 also displays a keyboard comprising numeral keys. Thus, through the touch function, users may operate the cellular phone 60 by touching the surface of the display panel.

The display device 61 comprises the CS driving device 14 with the capacitive coupling driving of the above embodiments. In the first scan frame period after the power source of the display device 61 is input thereto, display noise is not induced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An active matrix display device comprising:
a plurality of pixels Pnm arranged in a matrix formed by pixel rows and pixel columns, wherein each of the pixels comprises a pixel electrode 20, a display element 23, a storage capacitor 24 coupled to the display element 23 through the pixel electrode 20, and a switch element 21;
a signal line driving device 12 for driving a plurality of signal lines 16-1˜16-m respectively disposed in the pixel columns;
a scan line driving device 13 for sequentially driving a plurality of scan lines 17-1˜17-n respectively disposed in the pixel rows and turning on the switch elements 21 one pixel row by one pixel row, so that the pixel electrodes 20 are coupled to the corresponding signal lines 17-1˜17-n; and
a capacitive storage driving device 14 synchronized with the scan line driving device 13 to drive a plurality of capacitive storage lines respectively disposed in the pixel rows, wherein the capacitive storage driving device 14 switches a potential of each of a plurality of electrodes between two values one pixel row by one pixel row, and each of the electrodes is disposed opposite to the corresponding pixel electrode through a storage capacitor 24 and is coupled to the corresponding capacitive storage line 18-1˜18-n,
wherein, after a power source of the active matrix display device is input and before the scan line driving device 13 starts scanning the scan lines 17-1˜17-n, the capacitive storage driving device 14 sets a potential of each of the capacitive storage lines 18-1˜18-n to be at one of the two values, which one is high level voltage and the other is low level voltage.

2. The active matrix display device as claimed in claim 1 further comprising:
a controller for controlling the capacitive storage driving device to set the potential of each of the capacitive storage lines to be at one of the two values,
wherein the controller generates a control signal, and the control signal corresponds to each of the capacitive storage lines or each of capacitive storage line sets, and
wherein each of the capacitive storage line sets comprises even numbers of capacitive storage lines comprising at least two capacitive storage lines.

3. The active matrix display device as claimed in claim 2, wherein the controller controls the capacitive storage driving device to switch polarities of the capacitive storage lines between the two values by every one capacitive storage line or every one capacitive storage line set; and
wherein the control signal generated by the controller has a polarity which corresponds to each of the capacitive storage lines and is controllable independently.

4. The active matrix display device as claimed in claim 1, wherein the active matrix display device is a liquid crystal display device and further comprises:
a first substrate where a circuit is formed, wherein the circuit comprises the signal lines, the scan lines, the pixel electrodes, the switch elements, the storage capacitors, and the capacitive storage lines; and
a second substrate where a common electrode is formed, wherein the common electrode is disposed opposite to the circuit through a liquid crystal layer,
wherein the capacitive storage driving device and the circuit are formed on the first substrate.

5. The active matrix display device as claimed in claim 1, wherein the active
a first substrate where a circuit is formed, wherein the circuit comprises the signal lines, the scan lines, the pixel electrodes, the switch elements, the storage capacitors, and the capacitive storage lines;
a second substrate where a common electrode is formed, wherein the common electrode is disposed opposite to the circuit through a liquid crystal layer; and
a driver integrated circuit comprising the signal line driving device, the scan line driving device, and the capacitive storage driving device.

6. An electronic apparatus comprising an active matrix display device as claimed in claim 1.
